(19) United States
(12) Patent Application Publication
(10) Pub. No.: US 2021/0287210 A1
(43) Pub. Date: Sep. 16, 2021

(54) Blockchain Transaction Storing and Queuing Method

(71) Applicant: Hangzhou Fuzamei Complex Beauty Technology Co., Ltd., Hangzhou, Zhejiang (CN)

(72) Inventors: Sijin Wu, Hangzhou, Zhejiang (CN); Zhiwen Wang, Hangzhou, Zhejiang (CN)

(21) Appl. No.: 16/603,430

(22) PCT Filed: Nov. 9, 2018
(86) PCT No.: PCT/CN2018/114899

§ 371 Date: Oct. 7, 2019

(30) Foreign Application Priority Data
Nov. 10, 2017 (CN) 201711101286.2

(51) Int. Cl. G06Q 20/38; G06F 16/23

(52) U.S. Cl. CPC G06Q 20/389; G06Q 20/3827; G06F 16/2379

(57) ABSTRACT

Disclosed in the present invention are a block chain transaction storage method and queuing method. Said method comprises: writing a certain few bits of a transaction hash value into a bitmap table, one bit being able to store only one transaction hash value satisfying the condition, queuing other transactions satisfying the condition; consensus nodes performing mining, the consensus node N which firstly calculates a Merkel root hash value broadcasting the Merkel root hash value and its own bitmap table to other consensus nodes; by comparing the bitmap tables, quickly searching for missing or inconsistent data; and generating a block after consensus is reached. In cases where the transaction volume is huge and the transaction is congested, a user can set the priority of the transaction queuing according to his own demand.

### TECHNICAL FIELD

The present disclosure relates to the technical field of blockchains.

### BACKGROUND

According to the existing blockchain transaction storing method, a consensus node verifies consistency of data of two parties through Merkle root hash values, and if the obtained Merkle root hash values are inconsistent, it needs to retrieve hash values of leaf nodes of each layer from top to bottom till a transaction hash value generating an error at a bottom layer is found out so as to judge which one transaction generates the error; and only after the transaction is corrected and transaction data reaches a consensus, the transaction can be stored in a block. Such process wastes a large amount of time and hash rate.

The existing blockchain transaction barely has a transaction queuing method, or only simply sets different charge levels to change queuing priority of transactions, wherein the queuing priority of the transactions cannot be flexibly changed according to user requirements.

### SUMMARY

In order to overcome the defects of the prior art, the present disclosure provides a blockchain transaction storing and queuing method.

Technical solutions adopted by the present disclosure are as follows.

1. A blockchain transaction storing and queuing method comprises the following steps:

Step S1: each transaction generates a transaction hash value, certain bits (such as first three bits) of the transaction hash value are written into a bitmap table, one bit can only store one transaction hash value meeting conditions, and other transactions meeting the conditions are queued, for example, certain bits (such as first three bits) of the transaction hash value are written into the bitmap table, and 3(011) bit only can store a transaction having 011 as certain bits (such as first three bits) of the transaction hash value;

Step S2: a status code of a bit in which the transaction is stored is converted from 0 to 1, and the status code of a bit in which no transaction is stored is always 0;

Step S3: consensus nodes mine, and a consensus node N, which obtains a Merkle root hash value at the earliest, broadcasts the Merkle root hash value and itself bitmap table to another consensus node;

Step S4: the other consensus node calculates a Merkle root hash value; if the obtained Merkle root hash value is the same as the Merkle root hash value of the consensus node N, it represents that transaction data is completely consistent; and if the obtained Merkle root hash value is different, a bitmap of the other consensus node is compared with a bitmap of the consensus node N so as to quickly find out missing or inconsistent data;

Step S5: a block H is generated after transactions reach a consensus; and

Step S6: when the volume of transactions is large and the transactions are congested, a user can pay fees to improve queuing priority; for example, there are two transactions 011AA and 011BB having 011 as the certain bits of the transaction hash value, the transaction having 011AA as the certain bits of the transaction hash value is prior to the transaction having 011BB as the certain bits of the transaction hash value, and according to a default queuing order, the transaction having 011AA as the certain bits of the transaction hash value is putted into a block H+1, and the transaction having 011BB as the certain bits of the transaction hash value is putted into a block H+2; and if the transaction having 011BB as the certain bits of the transaction hash value pays fees to improve the queuing priority but the transaction having 011AA as the certain bits of the transaction hash value does not pay the fees, the transaction having 011BB as the certain bits of the transaction hash value is putted into the block H+1, and the transaction having 011AA as the certain bits of the transaction hash value is putted into the block H+2.

2. If the calculated Merkle root hash value of the consensus node is different from the Merkle root hash value of the consensus node N, the bitmap table of the consensus node N is compared with the bitmap table of the consensus node; specifically, exclusive OR is performed on the status code of the consensus node N and the status code of the consensus node; if a status code of a bit is the same, an exclusive OR value is 0; and if the status code of the bit is different, the exclusive OR value is 1. The missing or inconsistent data can be quickly found out by the status codes of exclusive OR bitmaps.

3. At some moments, the volume of transactions is large, the transactions are congested, the height of queuing blocks is defaulted to be M blocks, and if a transaction is not stored in a block after waiting for the M blocks, the transaction is defaulted to abandon to queue.

4. The user can pay fees to improve the queuing priority. A blockchain transaction storage queuing method can depend on the number of bytes of transactions, a charge level, a block height range or any combination thereof.

5. When the transactions are congested, fee payment can effectively prevent some users from performing zero-cost malicious scalping. A malicious scalping transaction does not pay the fees so as to have lower queuing priority; and after the malicious scalping transaction is not stored in the block after waiting for the M blocks, the malicious scalping transaction is defaulted to abandon to queue, thereby effectively preventing some users from performing a zero-cost malicious scalping attack on a blockchain system.

6. After the user pays the fees to improve the queuing priority, and if the transactions are not congested at this time, the blockchain system automatically reduces or remit the paid fees.

7. If an account credit level of the user is high, the blockchain system can reduce relative fees during transaction.

8. Some users need to perform a pending order, that is, a transaction is performed after a user-specified amount is achieved, and in this case, the users need to additionally pay subscription fee and queuing fee.

9. If the pending order is performed at a transaction congestion time, its queuing priority can also be improved by fee payment, and the pending order queuing method can depend on the number of bytes of transactions, the charge level, the block height range or any combination thereof.

10. The user can cancel a transaction before the transaction is not completed.

11. A timeout period T is appointed, and only within the timeout period T, the transaction can be putted into the block; and after the timeout period T is over, the transaction cannot be putted into the block even if a bit corresponding to the transaction hash value of the transaction does not store the transaction.

### BRIEF DESCRIPTION OF THE DRAWINGS

FIG. 1 is a schematic diagram simulating a process of a blockchain transaction storing and queuing method provided by embodiments of the present disclosure; and

FIG. 2 is a schematic diagram simulating verification of transaction data provided by embodiments of the present disclosure.

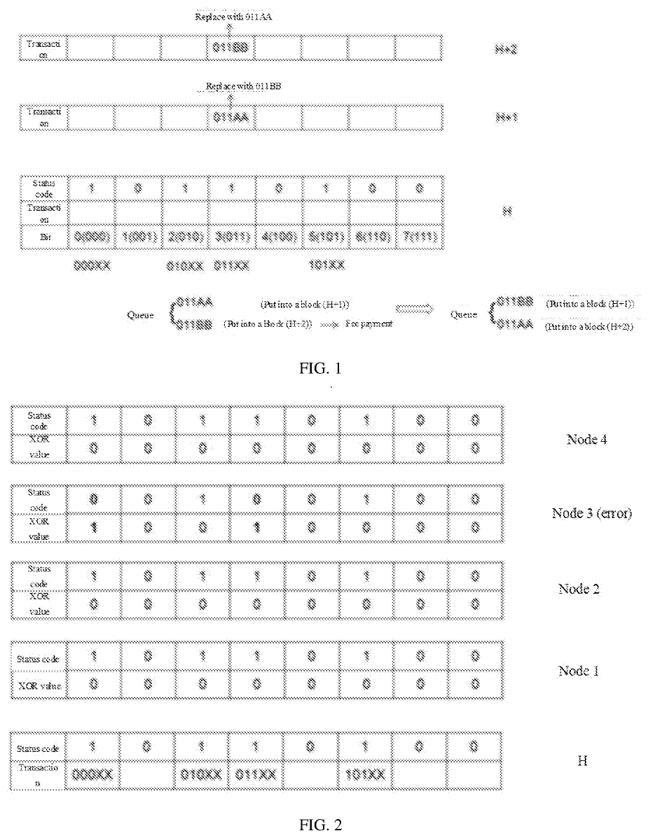

### DESCRIPTION OF THE EMBODIMENTS

The present disclosure is further described below with reference to the accompanying drawings.

1. A blockchain transaction storing and queuing method comprises the following steps:

Step S1: each transaction generates a transaction hash value, certain bits (such as first three bits) of the transaction hash value are written into a bitmap table, one bit can only store one transaction hash value meeting conditions, and other transactions meeting the conditions are queued, for example, certain bits (such as first three bits) of the transaction hash value are written into the bitmap table, and 3(011) bit only can store a transaction having 011 as certain bits (such as first three bits) of the transaction hash value;

Step S2: a status code of a bit in which the transaction is stored is converted from 0 to 1, and the status code of a bit in which no transaction is stored is always 0;

Step S3: consensus nodes mine, and a consensus node N, which obtains a Merkle root hash value at the earliest, broadcasts the Merkle root hash value and itself bitmap table to another consensus node;

Step S4: the other consensus node calculates a Merkle root hash value; if the obtained Merkle root hash value is the same as the Merkle root hash value of the consensus node N, it represents that transaction data is completely consistent; and if the obtained Merkle root hash value is different, a bitmap of the other consensus node is compared with a bitmap of the consensus node N so as to quickly find out missing or inconsistent data;

Step S5: a block H is generated after transactions reach a consensus; and

Step S6: when the volume of transactions is large and the transactions are congested, a user can pay fees to improve queuing priority; for example, there are two transactions 011AA and 011BB having 011 as the certain bits (such as first three bits) of the transaction hash value, the transaction having 011AA as the certain bits (such as first three bits) of the transaction hash value is prior to the transaction having 011BB as the certain bits (such as first three bits) of the transaction hash value, and according to a default queuing order, the transaction having 011AA as the certain bits (such as first three bits) of the transaction hash value is putted into a block H+1, and the transaction having 011BB as the certain bits (such as first three bits) of the transaction hash value is putted into a block H+2; and if the transaction having 011BB as the certain bits (such as first three bits) of the transaction hash value pays fees to improve the queuing priority but the transaction having 011AA as the certain bits (such as first three bits) of the transaction hash value does not pay the fees, the transaction having 011BB as the certain bits (such as first three bits) of the transaction hash value is putted into the block H+1, and the transaction having 011AA as the certain bits (such as first three bits) of the transaction hash value is putted into the block H+2.

2. If the calculated Merkle root hash value of the consensus node is different from the Merkle root hash value of the consensus node N, the bitmap table of the consensus node N is compared with the bitmap table of the consensus node; specifically, exclusive OR is performed between the status code of the consensus node N and the status code of the consensus node; if a status code of a bit is the same, an exclusive OR value is 0; and if the status code of the bit is different, the exclusive OR value is 1. The missing or inconsistent data can be quickly found out by the status codes of exclusive OR bitmaps.

3. At some moments, the volume of transactions is large, the transactions are congested, the height of queuing blocks is defaulted to be M blocks, and if a transaction is not stored in a block after waiting for the M blocks, the transaction is defaulted to abandon to queue.

4. The user can pay fees to improve the queuing priority. A blockchain transaction storage queuing method can depend on the number of bytes of transactions, a charge level, a block height range or any combination thereof.

5. When the transactions are congested, fee payment can effectively prevent some users from performing zero-cost malicious scalping. A malicious scalping transaction does not pay the fees so as to have lower queuing priority; and after the malicious scalping transaction is not stored in the block after waiting for the M blocks, the malicious scalping transaction is defaulted to abandon to queue, thereby effectively preventing some users from performing a zero-cost malicious scalping attack on a blockchain system.

6. After the user pays the fees to improve the queuing priority, and if the transactions are not congested at this time, the blockchain system automatically reduces or remit the paid fees.

7. If an account credit level of the user is high, the blockchain system can reduce relative fees during transaction.

8. Some users need to perform a pending order, that is, a transaction is performed after a user-specified amount is achieved, and in this case, the users need to additionally pay subscription fee and queuing fee.

9. If the pending order is performed at a transaction congestion time, its queuing priority can also be improved by fee payment, and the pending order queuing method can depend on the number of bytes of transactions, the charge level, the block height range or any combination thereof.

10. The user can cancel a transaction before the transaction is not completed.

11. A timeout period T is appointed, and only within the timeout period T, the transaction can be putted into the block; and after the timeout period T is over, the transaction cannot be putted into the block even if a bit corresponding to the transaction hash value of the transaction does not store the transaction.

The present disclosure provides a blockchain transaction storing method to greatly accelerate storage speed and verification speed of the transaction data. The present disclosure further provides a blockchain transaction queuing method, and the user can change the priority of the transactions according to the queuing method such that transaction queuing flexibility is greatly improved and the user is effectively prevented from performing zero-cost malicious scalping attacks.

What is claimed is:

1. A blockchain transaction storing and queuing method, wherein the blockchain transaction storing and queuing method comprises the following steps:
Step S1: each transaction generates a transaction hash value, certain bits of the transaction hash value are written into a bitmap table, one bit can only store one transaction hash value meeting conditions, other transactions meeting the conditions are queued, certain bits of the transaction hash value are written into the bitmap table, and 3(011) bit only can store a transaction having 011 as the certain bits of the transaction hash value;
Step S2: a status code of a bit in which the transaction is stored is converted from 0 to 1, and the status code of a bit in which no transaction is stored is always 0;
Step S3: consensus nodes mine, and a consensus node N, which obtains a Merkle root hash value at the earliest, broadcasts the Merkle root hash value and itself bitmap table to another consensus node;
Step S4: the other consensus node calculates a Merkle root hash value; if the obtained Merkle root hash value is the same as the Merkle root hash value of the consensus node N, it represents that transaction data is completely consistent; and if the obtained Merkle root hash value is different, a bitmap of the other consensus node is compared with a bitmap of the consensus node N so as to quickly find out missing or inconsistent data;
Step S5: a block H is generated after transactions reach a consensus; and
Step S6: when the volume of transactions is large and the transactions are congested, a user can pay fees to improve queuing priority.

2. The blockchain transaction storing and queuing method according to claim 1, wherein if the calculated Merkle root hash value of the consensus node is different from the Merkle root hash value of the consensus node N, the bitmap table of the consensus node N is compared with the bitmap table of the consensus node; specifically, exclusive OR is performed on the status code of the consensus node N and the status code of the consensus node; if a status code of a bit is the same, an exclusive OR value is 0; if the status code of the bit is different, the exclusive OR value is 1; and the missing or inconsistent data can be quickly found out by the status codes of exclusive OR bitmaps.

3. The blockchain transaction storing and queuing method according to claim 1, wherein at some moments, the volume of transactions is large, the transactions are congested, the height of queuing blocks is defaulted to be M blocks, and if a transaction is not stored in a block after waiting for the M blocks, the transaction is defaulted to abandon to queue.

4. The blockchain transaction storing and queuing method according to claim 1, wherein the user can pay fees to improve the queuing priority; and a blockchain transaction storage queuing method can depend on the number of bytes of transactions, a charge level, a block height range or any combination thereof.

5. The method according to claim 4, wherein fee payment can effectively prevent some users from performing zero-cost malicious scalping when the transactions are congested; and a malicious scalping transaction does not pay the fees so as to have lower queuing priority; and after the malicious scalping transaction is not stored in the block after waiting for the M blocks, the malicious scalping transaction is defaulted to abandon to queue, thereby effectively preventing some users from performing a zero-cost malicious scalping attack on a blockchain system.

6. The method according to claim 4, wherein after the user pays the fees to improve the queuing priority, and if the transactions are not congested at this time, the blockchain system automatically reduces or remit the paid fees.

7. The method according to claim 4, wherein if an account credit level of the user is high, the blockchain system can reduce relative fees during transaction.

8. The blockchain transaction storing and queuing method according to claim 1, wherein some users need to perform a pending order, that is, a transaction is performed after a user-specified amount is achieved, and in this case, the users need to additionally pay subscription fee and queuing fee.

9. The method according to claim 8, wherein if the pending order is performed at a transaction congestion time, its queuing priority can also be improved by fee payment, and the pending order queuing method can depend on the number of bytes of transactions, the charge level, the block height range or any combination thereof.

10. The blockchain transaction storing and queuing method according to claim 1, wherein the user can cancel a transaction before the transaction is not completed.

11. The blockchain transaction storing and queuing method according to claim 1, wherein a timeout period T is appointed, and only within the timeout period T, the transaction can be putted into the block; and after the timeout period T is over, the transaction cannot be putted into the block even if a bit corresponding to the transaction hash value of the transaction does not store the transaction.
